(19) United States
(12) Patent Application Publication
(10) Pub. No.: US 2010/0248131 A1
(43) Pub. Date: Sep. 30, 2010

(54) IMAGE FORMING APPARATUS AND IMAGE FORMING METHOD

(75) Inventors: Masahiro MAEDA, Matsumoto-shi (JP); Yoichi YAMADA, Shiojiri-shi (JP); Masaru KOBASHI, Matsumoto-shi (JP); Tomohiro ARUGA, Matsumoto-shi (JP); Takatomo FUKUMOTO, Shiojiri-shi (JP); Atsunori KITAZAWA, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/727,300

(22) Filed: Mar. 19, 2010

(30) Foreign Application Priority Data
Mar. 26, 2009 (JP) 2009-077270

(51) Int. Cl. G03G 13/16; G03G 21/00

(52) U.S. Cl. 430/125.4; 399/346

(57) ABSTRACT

Provided is an image forming apparatus including: a latent image carrier; a lubricant applying unit configured to bring a conductive contact member into contact with a surface of the latent image carrier; a development unit configured to attach toner to the surface of the latent image carrier; and a conductive blade brought into contact with the surface of the latent image carrier at a cleaning position, wherein a bias is applied to at least one of the conductive contact member and the conductive blade such that the surface of the latent image carrier is electrified, and wherein, as the durability of the conductive blade is prolonged, a ratio of the electrification of the surface of the latent image carrier by the conductive blade and the electrification of the surface of the latent image carrier by the conductive contact member is changed.

### BACKGROUND

1. Technical Field

The present invention relates to an image forming apparatus and image forming method for developing an electrostatic latent image formed on a latent image carrier by using toner so as to form a toner image and, more particularly, relates to the cleaning and electrification of the surface of the latent image carrier.

2. Related Art

There is known an image forming apparatus and image forming method for developing an electrostatic latent image, which is formed on a latent image carrier rotating in a predetermined rotation direction, by using toner so as to form a toner image and transferring the toner image onto a transfer medium. In the image forming apparatus and image forming method, since transfer efficiency from the latent image carrier to the transfer medium is 100% or less, a small amount of toner may remain on the surface of the latent image carrier after transfer. Therefore, in this type of image forming apparatus, a so-called blade type cleaning unit has been widely used to bring a cleaning blade into contact with the surface of the latent image carrier at a cleaning position located at a downstream side of a transfer position in the rotation direction of the latent image carrier so as to remove the residual toner after transfer.

However, recently, in order to achieve highly precise images, an increase in process speed and a decrease in fixing temperatures, employment of toner is being examined which has a smaller particle diameter than that of toner which has been used up to now (for example, toner having a volume average particle diameter of 5 μm or less and circularity of the toner of 0.95 or more). Since the toner having a small particle diameter is not all captured by a cleaning blade, it is difficult to eliminate the residual toner after transfer from the latent image carrier. In addition, there is a problem that a filming layer may be gradually formed on the surface of the latent image carrier due to the residual toner after transfer such that transfer performance deteriorates or a friction coefficient of the cleaning blade and the latent image carrier may be increased such that the latent image carrier is damaged.

Therefore, for example, in an apparatus described in JP-A-2007-86262 (FIG. 1), the above problems are solved by applying a lubricant to the surface of a photoreceptor. That is, an application brush is brought into contact with solid zinc stearate (lubricant), and zinc stearate is shaved off and is applied to the surface of the photoreceptor by the application brush. Accordingly, since the lubricant layer is formed on the surface of the photoreceptor as a protective film of the photoreceptor, the toner having the small particle diameter may be cleaned and removed from the surface of the photoreceptor by the cleaning blade with certainty, even when an image is formed using the toner having the small particle diameter. The surface of the photoreceptor which is cleaned by the cleaning blade is electrified to a predetermined surface potential by an electrification member disposed on the downstream side of the cleaning position.

However, from the viewpoint of a reduction in size of the apparatus or a decrease in the number of parts, it may be considered that, for example, a technique described in JP-A-4-304476 (FIGS. 2 and 5), that is, a technique of adding an electrification function and a cleaning function to a cleaning blade applies to a device described in JP-A-2007-86262. However, in an image forming apparatus having such a combination, an electrification bias is applied to a cleaning blade in order to electrify the surface of a latent image carrier such as a photoreceptor drum or a photoreceptor belt. In addition, a load is applied to the surface of the latent image carrier in order to press the cleaning blade. Due to the influence of the electrification bias or the load, an attachment such as a discharge product, toner or lubricant is deposited on a portion of a front end of the cleaning blade, which is in contact with the surface of the latent image carrier, such that electrification uniformity deteriorates. If durability of the cleaning blade (corresponding to a “conductive blade” of the invention) including the electrification function and the cleaning function is prolonged, electrification performance and image quality deteriorate.

### SUMMARY

An advantage of some aspects of the invention is that electrification uniformity is maintained by a small number of parts over a long period of time in an image forming apparatus and method for performing an electrification process and a cleaning process with respect to a surface of a latent image carrier and a process of applying a lubricant to the surface of the latent image carrier.

According to an aspect of the invention, there is provided an image forming apparatus including: a latent image carrier rotating in a predetermined rotation direction; a lubricant applying unit configured to bring a conductive contact member into contact with a surface of the latent image carrier at a predetermined application position so as to apply a lubricant; a development unit configured to attach toner to the surface of the latent image carrier, to which the lubricant is applied, at a development position located on a downstream side of the application position in the rotation direction so as to form a toner image; and a conductive blade brought into contact with the surface of the latent image carrier at a cleaning position located on an upstream side of the development position in the rotation direction so as to remove the toner on the surface of the latent image carrier, wherein a bias is applied to at least one of the conductive contact member and the conductive blade such that the surface of the latent image carrier is electrified, and wherein, as the durability of the conductive blade is prolonged, a ratio of the electrification of the surface of the latent image carrier by the conductive blade and the electrification of the surface of the latent image carrier by the conductive contact member is changed.

According to another aspect of the invention, there is provided an image forming method including: bringing a conductive contact member into contact with a surface of a latent image carrier rotating in a predetermined rotation direction so as to apply a lubricant; attaching toner to the surface of the latent image carrier, to which the lubricant is applied, to form a toner image; transferring the toner image onto a transfer medium; bringing a conductive blade into contact with the surface of the latent image carrier so as to clean and remove the toner remaining on the surface of the latent image carrier after transfer; and applying a bias to at least one of the conductive contact member and the conductive blade so as to electrify the surface of the latent image carrier, wherein, in the electrifying, as the durability of the conductive blade is prolonged, a ratio of the electrification of the surface of the latent image carrier by the conductive blade and the electrification of the surface of the latent image carrier by the conductive contact member is changed.

In the invention (the image forming apparatus and the image forming method) having the above configuration, the conductive blade is brought into contact with the surface of the latent image carrier so as to clean and remove the toner, and the bias is applied to the conductive blade such that the cleaning process and the electrification process can be executed with respect to the surface of the latent image carrier. In addition, the conductive contact member is brought into contact with the surface of the latent image carrier so as to apply the lubricant, and the bias is applied to the conductive contact member such that the lubricant application process and the electrification process can be executed with respect to the surface of the latent image carrier. In the invention, the bias is applied to at least one of the conductive blade and the conductive contact member so as to perform the electrification process. Accordingly, the electrification process can be performed by a small number of parts.

When the electrification of the surface of the latent image carrier by the conductive blade is continuously performed, the durability of the conductive blade is prolonged, but a discharge product or an attachment such as the toner or the lubricant is deposited on the front end of the conductive blade, that is, a portion which is in contact with the surface of the latent image carrier and thus electrification uniformity deteriorates. In the invention, as the durability of the conductive blade is prolonged, the ratio of the electrification of the surface of the latent image carrier by the conductive blade and the electrification of the surface of the latent image carrier by the conductive contact member is changed. Accordingly, the ratio of the electrification of the surface of the latent image carrier by the conductive contact member is increased as the durability of the conductive blade is prolonged and thus electrification uniformity can be maintained over a long period of time.

As a detailed method of changing the ratio, for example, a switching unit may be provided for switching a point at which the bias is applied. That is, if the switching unit sets the conductive blade as the point at which the bias is applied, the cleaning process and the electrification process are simultaneously executed by the conductive blade at the cleaning position and only the lubricant application process is executed at the application position. If the durability of the conductive blade is prolonged such that the electrification uniformity deteriorates, the switching unit switches the point at which the bias is applied to the conductive contact member, and the surface of the latent image carrier is electrified by the conductive contact member so as to improve electrification uniformity. By switching the point at which the bias is applied, the electrification uniformity can be maintained over a long period of time. Since the application of the bias to the conductive blade is completely stopped by the switching of the point at which the bias is applied, only the cleaning process by the conductive blade is executed at the cleaning position. As a result, it is possible to improve cleaning performance, compared with the case where the electrification process is simultaneously performed.

Although the positional relationship between the cleaning position and the application position is arbitrary, if the point at which the bias is applied is switched by the switching unit, the cleaning position is located on the downstream of the application position in the rotation direction. By employing the arrangement relationship, the lubricant applied to the surface of the latent image carrier by the lubricant applying unit becomes uniform by using the conductive blade such that uniform lubricant film can be formed on the surface of the latent image carrier.

As another method of changing the ratio, for example, the cleaning position may be located at the upstream side of the application position in the rotation direction and the same direct current voltage may be applied to both the conductive contact member and the conductive blade as the bias. By the bias being applied, the electrification process can be executed with respect to the surface of the latent image carrier at any one of the cleaning position and the application position, but the main part of the electrification process is performed at the cleaning position on the upstream side, that is, the electrification of the surface of the latent image carrier by the conductive blade. Accordingly, before the durability of the conductive blade is prolonged, the surface of the latent image carrier is uniformly electrified by the conductive blade at the cleaning position. To this end, since the surface of the latent image carrier moved to the application position is already electrified, the electrification process at the application position is not performed or is performed as an auxiliary. However, if the durability of the conductive blade is prolonged and the electrification uniformity of the surface of the latent image carrier by the conductive blade deteriorates, the electrification of a region, which is not sufficiently electrified, out of the surface of the latent image carrier moved to the application position is performed by the conductive contact member such that the electrification uniformity of the surface of the latent image carrier is improved. Although the main part of the electrification of the surface of the latent image carrier is performed by the conductive blade when the apparatus begins to be used, the ratio of the electrification by the conductive contact member is increased as the durability of the conductive blade is prolonged and the electrification uniformity of the surface of the latent image carrier is ensured. As a result, the electrification uniformity of the surface of the latent image carrier is maintained over a long period of time.

With respect to the electrification process of the surface of the latent image carrier, 1-step electrification may be performed by applying the bias to at least one of the conductive blade and the conductive contact member or 2-step electrification may be performed by adding a secondary electrification by the electrification device. In the latter case, the electrification device is disposed on the downstream side of the conductive blade and the conductive contact member in the rotation direction. The surface of the latent image carrier is electrified to the first potential by applying the bias and the surface of the latent image carrier electrified to the first potential is electrified to the second potential by the electrification device at the secondary electrification position. By using 2-step electrification, it is possible to further improve the electrification uniformity of the surface of the latent image carrier.

As an example of the 2-step electrification, the direct current voltage having the same polarity as a regular electrification polarity of the toner may be applied to at least one of the conductive blade and the conductive contact member as the bias such that the surface of the latent image carrier is electrified to the first potential having the same polarity as the regular electrification polarity, and electric charge having a polarity opposite to the regular electrification polarity are applied by the electrification device such that the potential of the surface of the latent image carrier is adjusted to the second potential. Accordingly, it is possible to more uniformly electrify the surface of the latent image carrier.

In the 1-step electrification, an overlapping voltage in which an alternating current voltage overlaps with a direct current voltage having the same polarity as a regular electrification polarity of the toner may be applied to at least one of the conductive blade and the conductive contact member as the bias such that the surface of the latent image carrier is electrified. By overlapping the alternating current voltage with the direct current voltage, it is possible to improve the electrification uniformity of the surface of the latent image carrier, compared with the 1-step electrification of applying only the direct current voltage as the bias.

As the conductive contact member, for example, an application brush roller may be used. In addition, it is desirable to provide the application brush roller as follows. That is, when configured such that a movement direction of a front end of the brush of the application brush roller may be the same as a movement direction of the surface of the latent image carrier at the application position, and the front end of the brush may be rotated while being brought into contact with the surface of the latent image carrier. Accordingly, it is possible to decrease the damage to the latent image carrier and to suppress the introduction of the toner into the brush so as to increase the life span of the application brush roller.

It is preferable that a movement velocity of the front end of the brush at the application position may be faster than a movement velocity of the surface of the latent image carrier at the application position. By such a configuration, it is possible to stably apply the lubricant to the surface of the latent image carrier and to further improve the electrification uniformity.

As the development unit, a so-called non-contact development unit may be used for applying the toner from the toner carrier disposed to face the latent image carrier in a non-contact position to the surface of the latent image carrier so as to form the toner image. That is, an external additive separated from the toner becomes attached to the toner carrier, and, when the external additive jumps from the toner carrier and is attached to the latent image carrier, the surface of the latent image carrier cannot be uniformly electrified and this causes defects in the image. Since the toner carrier and the latent image carrier are separated in the non-contact development method, it is difficult for the external additive separated from the toner and attached to the toner carrier to jump to the latent image carrier. Thus, it is possible to suppress the generation of the above problem. In addition, if the toner carrier is composed of a metallic development roller, the mirror image force of the external additive against the toner carrier is increased and the external additive is more efficiently prevented from jumping to the latent image carrier.

With respect to the used toner, a toner containing an external additive having polishing effect may be preferable. That is, when the toner adheres to a ridge portion in which the conductive blade is in contact with the latent image carrier, the electrification property or the cleaning property deteriorates. However, in the invention, since the lubricant is applied to the surface of the latent image carrier, the adhesion of the toner to the ridge portion is prompted by the lubricant. However, since the toner contains the external additive having the polishing effect, the toner or the lubricant adhered to the ridge portion of the conductive blade is polished by the external additive and the growth of the adhered toner is suppressed. To this end, it is possible to satisfactorily perform the electrification process and the cleaning process of the surface of the latent image carrier over a long period of time. As the external additive having the polishing effect, for example, strontium titanate may be used.

The toner may contain an external additive having a leak function. By this configuration, it is possible to prevent deterioration of the electrification potential. That is, the electrification at the cleaning position and the electrification position becomes unstable while the cleaning and the electrification are repeated by the conductive blade and thus the electrification potential may deteriorate. However, if the external additive having the leak function is contained in the toner, even when the toner is attached to the conductive blade due to long-term use, electric charges may be applied to the surface of the latent image carrier through the leak external additive so as to uniformly electrify the surface of the latent image carrier. As a result, it is possible to satisfactorily form an image over a long period of time without generating electrification failure. As the external additive having the leak function, titania, semiconductor oxide, or inorganic particles obtained by applying a semi-conductive film to at least a portion of a surface may be used.

### BRIEF DESCRIPTION OF THE DRAWINGS

The invention will be described with reference to the accompanying drawings, wherein like numbers reference like elements.

FIG. 1 is a diagram schematically showing the main configuration of an image forming apparatus according to a first embodiment of the invention.

FIG. 2 is a block diagram showing the electrical configuration of the apparatus of FIG. 1.

FIG. 3 is a flowchart showing the operation of the apparatus of FIG. 1.

FIG. 4 is a diagram showing a relationship between a voltage applied to a blade and blade current in the apparatus of FIG. 1.

FIG. 5 is a diagram schematically showing the main configuration of an image forming apparatus according to a second embodiment of the invention.

FIG. 6 is an enlarged schematic diagram of the vicinity of a cleaning position.

### DESCRIPTION OF EXEMPLARY EMBODIMENTS

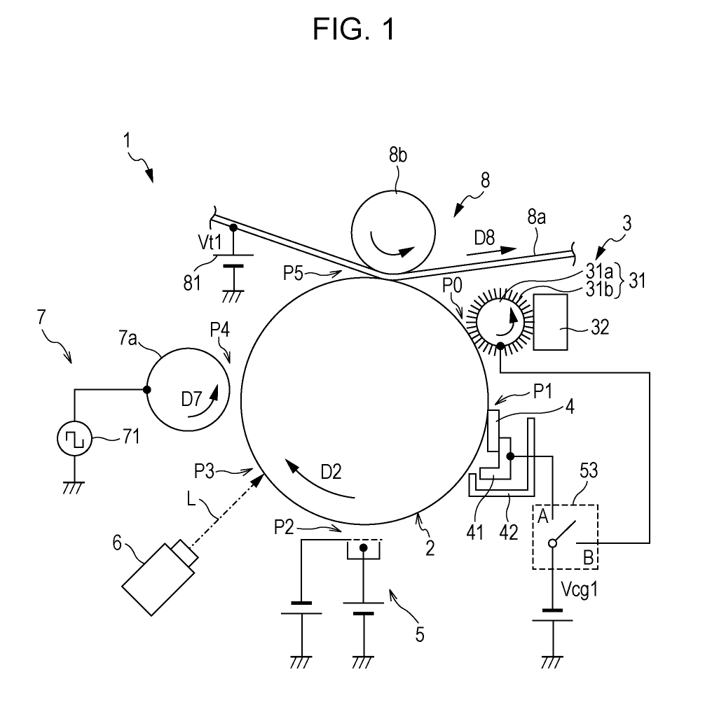

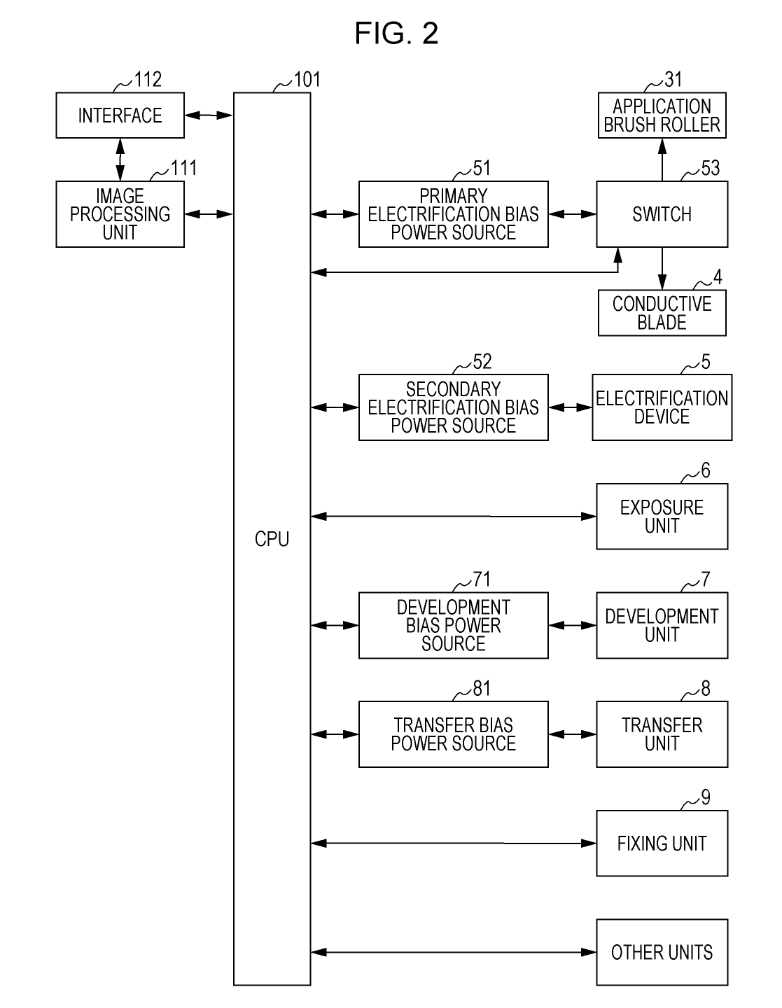

FIG. 1 is a diagram schematically showing the main configuration of an image forming apparatus according to a first embodiment of the invention. FIG. 2 is a block diagram showing the electrical configuration of the apparatus of FIG. 1. In the image forming apparatus 1, an image is formed using nonmagnetic monocomponent negatively-electrified toner. That is, in the first embodiment, a negative polarity is a “regular electrification polarity”. Alternatively, an image may be formed using positively electrified toner using a positive polarity as a regular electrification polarity. Although, in the following description, the image forming apparatus 1 uses negatively electrified toner, the electrification potentials of the members of the following description are set to opposite polarities if positively electrified toner is used. The toner includes toner mother particles and an external additive added to the toner mother particles. In the following description, the “toner” indicates whole particles in which the external additive is added to the toner mother particles.

As shown in FIG. 1, the image forming apparatus 1 includes a photoreceptor 2 on which an electrostatic latent image and a toner image are formed. The photoreceptor 2 is composed of a photoreceptor drum, and a photosensitive layer with a predetermined film thickness is formed on an outer circumferential surface of a cylindrical metallic tube similar to a known photoreceptor drum. For example, a conductive tube formed of aluminum or the like is used in the metallic tube of the photoreceptor 2 and a known organic photoreceptor is used in the photosensitive layer. In the first embodiment, the photoreceptor 2 corresponds to a “latent image carrier” of the invention.

In the periphery of the photoreceptor 2, a lubricant applying unit 3 for applying a lubricant to the surface of the photoreceptor 2 using an application brush roller 31, a conductive blade 4 for cleaning and removing residual toner after transfer, an electrification device 5 for performing a secondary electrification process with respect to the surface of the photoreceptor 2 which is primarily electrified by the application brush roller 31 or the conductive blade 4 so as to adjust the potential of the surface of the photoreceptor 2 to a predetermined potential, an exposure unit 6 for exposing the surface of the photoreceptor 2 according to an image signal so as to form an electrostatic latent image, a development unit 7 for developing the electrostatic latent image to a toner image, and a transfer unit 8 for transferring the toner image, are arranged in this order along a rotation direction D2 (in FIG. 1, clockwise rotation) of the photoreceptor 2. In the following description, a position where the lubricant is applied by the lubricant applying unit 3 is called an application position P0, a position where the conductive blade 4 is brought into contact with the surface of the photoreceptor 2 so as to perform cleaning is called a cleaning position P1, a position where secondary electrification is performed by the electrification device 5 is called a secondary electrification position P2, a position where the exposure unit 6 irradiates a light beam L on the surface of the photoreceptor 2 is called an exposure position P3, a position where a development roller 7a of the development unit 7 and the photoreceptor 2 face each other is called a development position P4, and a position where the photoreceptor 2 and an intermediate transfer belt 8a are in contact with each other is called a transfer position P5. In the first embodiment, these positions are provided in the above order from the upstream side to the downstream side of the rotation direction D2 of the photoreceptor 2.

In the first embodiment, subsequent to the applying of the lubricant to the surface of the photoreceptor 2 by the lubricant applying unit 3 corresponding to a “lubricant applying unit” of the invention, 2-step electrification is performed with respect to the photoreceptor 2. That is, the surface of the photoreceptor 2 is primarily electrified by the application brush roller 31 or the conductive blade 4 and is then secondarily electrified by the electrification device 5 such that the surface of the photoreceptor 2 is uniformly electrified to a desired potential. The configurations and the operations of the lubricant applying unit 3, the conductive blade 4 and the electrification device 5 will be described in detail later, together with the cleaning operation of the residual toner after transfer.

The electrostatic latent image is formed on the surface of the electrified photoreceptor 2 by the exposure unit 6. The exposure unit 6 exposes the surface of the photoreceptor 2 by the light beam L according to the image signal received from an external device so as to form the electrostatic latent image corresponding to the image signal. In more detail, as shown in FIG. 2, when the image signal is supplied from the external device such as a host computer for generating the image signal through an interface 112, the image signal is subjected to a predetermined process by an image processing unit 111. The image signal is supplied to the exposure unit 6 by using a CPU 101 which controls the entire operation of the apparatus. The exposure unit 6 irradiates the light beam L onto the surface of the photoreceptor 2 according to the image signal so as to perform exposure, and, in an exposed surface region (exposure portion) of the photoreceptor 2, electric charges are neutralized so as to be changed to a surface potential different from that of a non-exposed surface region (non-exposure portion). Therefore, the electrostatic latent image corresponding to the image signal is formed on the photoreceptor 2.

The development unit 7 applies the toner to the formed electrostatic latent image such that the electrostatic latent image is developed by the toner. The development unit 7 of the image forming apparatus 1 of this example is a non-contact development unit in which the development roller 7a is not in contact with the photoreceptor 2. The development roller 7a is disposed to face the photoreceptor 2 at a predetermined gap, for example, 100 μm or more, and is rotated and driven in a direction D7 denoted by an arrow of FIG. 1. A development bias power source 71 applies a predetermined development bias Vb to the development roller 7a. In the first embodiment, the development roller 7a corresponds to a “toner carrier” of the invention.

The transfer unit 8 has the intermediate transfer belt 8a which is an endless belt, in which the toner image is carried on the surface thereof, and is rotating in a direction D8 denoted by an arrow of FIG. 1, and the intermediate transfer belt 8a is in contact with the surface of the photoreceptor 2 due to a backup roller 8b disposed near the photoreceptor 2. A transfer bias power source 81 applies a transfer bias Vt1 having a polarity opposite to the electrification polarity of the toner to the intermediate transfer belt 8a, and, by this operation, the toner image developed on the photoreceptor 2 is transferred (primarily transferred) onto the intermediate transfer belt 8a. The toner image transferred onto the intermediate transfer belt 8a is secondarily transferred onto a recording sheet (not shown) and is fixed on the recording sheet by a fixing unit 9 so as to be output.

The lubricant applying unit 3 is disposed at the application position P0 on the downstream of the transfer position P5 in the rotation direction D2 of the photoreceptor 2. The lubricant applying unit 3 includes an application brush roller 31 and a lubricant bar 32 which is lubricant solidified into a solid. The application brush roller 31 includes a rotatable roller body 31a and a plurality of hairs 31b attached to the outer circumferential surface of the roller body 31a. As the brush hairs 31b, for example, brush hairs formed from 2D fiber (denier) nylon and having raw-fiber resistance of 1.0×10⁷ to 1.0×10¹¹ Ωcm (manufactured by TOEISANGYO CO., LTD, corresponding to a product number UUN (6 nylon, carbon type, uniform dispersion type)) and brush hairs having brush density of 100 KF/inch² may be used. That is, carbon particles are dispersed in the brush hairs 31b so as to be adjusted to have proper conductivity. The application brush roller 31 is electrically connected to a primary electrification bias power source 51 through a switch 53, and, if the switch 53 is set at a position B by the CPU 101, a primary electrification bias voltage Vcg1 of negative Direct Current (DC) is applied by the primary electrification bias power source 51 controlled by the CPU 101. In the first embodiment, the application brush roller 31 corresponds to a “conductive contact member” of the invention, and, by controlling the switch 53, the primary electrification bias Vcg1 is applied to the application brush roller 31 at an appropriate timing such that the surface of the photoreceptor 2 is electrified to a negative potential, for example, −600 V.

In a state in which the application brush roller 31 is disposed to face the photoreceptor 2 such that the brush hairs 31b is brought into contact with the photoreceptor 2, the roller body 31a is configured to be rotated in the forward direction (the direction of the velocity of the tangential direction of the rotation of the photoreceptor 2 in the contact portion between the photoreceptor 2 and the brush hairs 31b and the direction of the velocity of the tangential direction of the rotation of the brush hairs 31b are the same direction) of the rotation of the photoreceptor 2, that is, the width direction. Accordingly, it is possible to reduce damage to the photoreceptor 2 and to suppress the introduction of toner into the brush hairs 31b so as to increase the life span of the application brush roller 31.

In the first embodiment, the application brush roller 31 is controlled to be rotated such that the movement velocity (the circumferential velocity of the application brush roller 31) of the front end of the brush at the application position P0, that is, the front end of the brush hairs 31b, is faster than the movement velocity (the circumferential velocity of the photoreceptor 2) of the surface of the photoreceptor 2 at the application position P0. Accordingly, it is possible to stably apply the lubricant to the surface of the photoreceptor 2 and to more uniformly electrify the surface of the photoreceptor 2 by the application brush roller 31.

The lubricant bar 32 is disposed on the opposite side (the right side of FIG. 1) of the photoreceptor 2 with the application brush roller 31 interposed therebetween, the brush hairs 31b of the rotating application brush roller 31 is in contact with the lubricant bar 32 such that the lubricant is shaved off, transferred onto the surface of the photoreceptor 2, and applied to the surface of the photoreceptor 2. The lubricant is applied to the surface of the photoreceptor 2 at the application position P0 such that a lubricant layer is formed on the surface of the photoreceptor 2. In addition, as the lubricant, for example, fatty acid metal salt may be used, or a powder-shaped lubricant may be used instead of the above-described solid lubricant. However, in order to solve a problem such as jumping, a solid lubricant is preferably used. As metal salt configuring fatty acid metal salt, for example, zinc, lithium, natrium, magnesium, aluminum, lead, nickel or the like may be used. As fatty acid configuring fatty acid metal salt, for example, stearic acid, lauric acid, palmitic acid or the like may be used. Among them, if the solid lubricant is used, stearic acid may be suitably used.

The lubricant bar 32 is consumed according to use and, in the first embodiment, the size of the lubricant bar 32 is determined such that there remains a predetermined amount of lubricant until at least the life span of the photoreceptor 2 is exhausted. If the photoreceptor 2 is configured by a process unit which may be detached from the body of the apparatus so as to be replaced, it is preferable that the lubricant bar 32 is received in the process unit. Accordingly, when the photoreceptor 2 is replaced with a new product, the lubricant bar 32 is updated, and the lubricant is prevented from being used up before the life span of the photoreceptor 2 is exhausted.

The conductive blade 4 is disposed at the cleaning position P1 on the downstream side of the application position P0 in the rotation direction D2. As the conductive blade 4, that obtained by applying conductivity to rubber, resin or the like or that obtained by performing a cleaning process with respect to the photoreceptor 2 compared with the related art may be used. In the first embodiment, the conductive blade 4 has a plate shape extending in a width direction (a vertical direction of the paper plane of FIG. 1) and the width-direction size thereof is slightly longer than the width of an image forming region of the photoreceptor 2. For example, when the width-direction size of the image forming region is 291 mm, the width-direction size of the conductive blade 4 may be set to 310 mm.

A rear end of the conductive blade 4 is a support member 41 formed of a metal material (including an alloy thereof) of stainless steel, iron, copper, aluminum, aluminum alloy, nickel, phosphor bronze or the like, a conductive resin, or a conductive material obtained by depositing metal having conductivity, such as aluminum, in a resin or the like. Meanwhile, a front end of the conductive blade 4 protrudes from a front end of the support member 41 so as to be in contact with the surface of the photoreceptor 2 at the cleaning position P1. In the first embodiment, the front end of the conductive blade 4 is in contact with the rotation direction D2 of the photoreceptor 2 in a counter direction and a contact angle (an inclination angle of the conductive blade 4 with respect to a tangential direction of the surface of the photoreceptor 2 at the cleaning position P1) of the conductive blade 4 is approximately set to 10°. In the first embodiment, the load of the conductive blade 4 against the photoreceptor 2 is set to 13 g/cm. By such a cleaning condition, the toner remaining on the surface of the photoreceptor 2 is scraped off by the conductive blade 4 such that the toner is cleaned and removed from the surface of the photoreceptor 2. In addition, the scraped toner is recovered to a toner recovery box 42 disposed at a lower position of the conductive blade 4 and the support member 41.

The conductive blade 4 is electrically connected to the primary electrification bias power source 51 through the switch 53 similar to the application brush roller 31, and, when the switch 53 is set to a position A by the CPU 101, the primary electrification bias voltage Vcg1 of negative DC is applied by the primary electrification bias power source 51 controlled by the CPU 101, and the surface of the photoreceptor 2 is electrified to a negative potential, for example, −600 V. In the first embodiment, by switching the connection position of the switch 53 using the CPU 101, a point at which the primary electrification bias Vcg1 is applied can be selected from the application brush roller 31 and the conductive blade 4. That is, the primary electrification bias Vcg1 is applied to the application brush roller 31 such that the primary electrification process is executed with respect to the surface of the photoreceptor 2 at the application position P0 and the primary electrification bias Vcg1 is applied to the conductive blade 4 such that the primary electrification process is executed with respect to the surface of the photoreceptor 2 at the cleaning position P1. In addition, in the first embodiment, the primary electrification bias Vcg1 corresponds to a “bias” of the invention.

In order to make the potential of the surface of the primarily electrified photoreceptor 2 uniform so as to improve electrification uniformity and to also secondarily electrify the potential of the surface to a potential (corresponding to a “second potential” of the invention) suitable for forming the image, the electrification device 5 is provided at the secondary electrification position P2 on the downstream side of the cleaning position P1 in the rotation direction D2 of the photoreceptor 2. In the first embodiment, the electrification device 5 is not in contact with the surface of the photoreceptor 2 and a known scorotron electrification device 5 is used. The scorotron electrification device 5 is electrically connected to a secondary electrification bias power source 52, positive wire current Iw flows in a charge wire 5b of the scorotron electrification device 5 as a secondary electrification bias, and a grid electrification bias Vg of negative DC is applied to a grid 5a. Accordingly, electric charges having a polarity (positive polarity) opposite to that of the toner are applied to the photoreceptor 2 by the electrification device 5 such that the potential of the surface of the photoreceptor 2 becomes approximately uniform, and the potential is adjusted from the first potential to the second potential, and more specifically, is adjusted to the potential of the surface set at the time of image formation. For example, a DC voltage of +4 kV is applied to the charge wire 5b plated with gold such that wire current Iw of +400 μA flows, and, when a DC voltage of −500 V is applied to the grid 5a, the potential of the surface of the photoreceptor 2 electrified by the primary electrification (−600 V) is adjusted to the approximately same value (−500 V).

The exposure process and the development process are sequentially executed with respect to the surface of the photoreceptor 2 electrified by the desired second potential so as to form the toner image, and the toner image is transferred onto the intermediate transfer belt (transfer medium) 8a by the transfer unit 8.

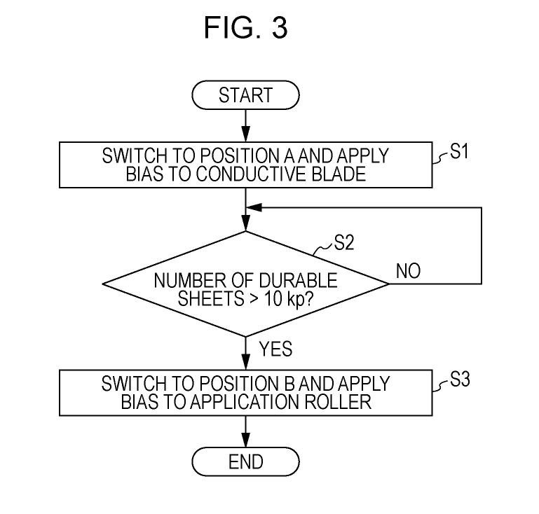

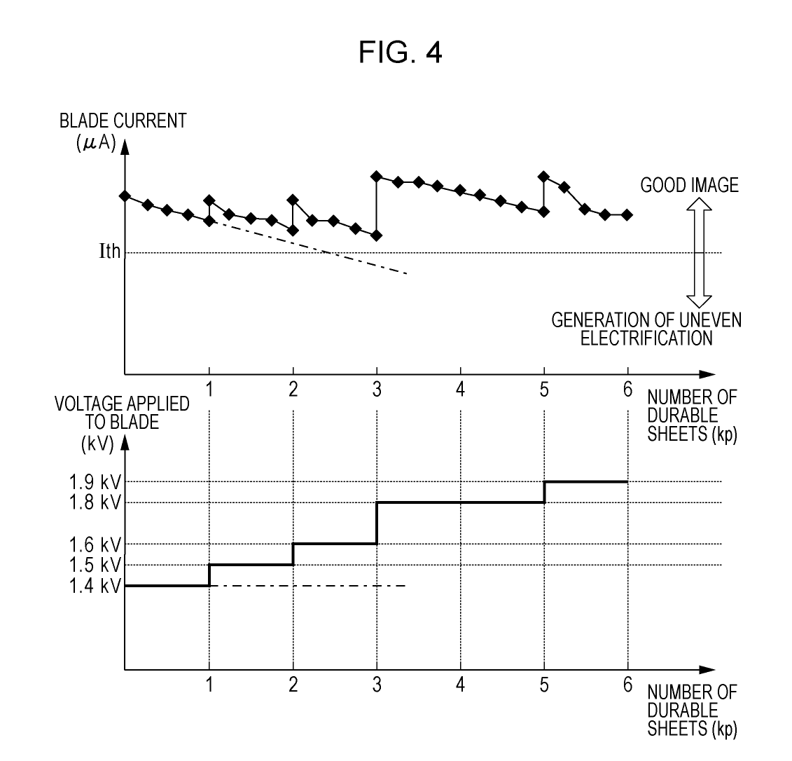

FIG. 3 is a flowchart showing the operation of the apparatus of FIG. 1. In the image forming apparatus 1 having the above configuration, the durability of the conductive blade 4 is not prolonged. If it is determined that the surface of the photoreceptor 2 can be uniformly primarily electrified by the conductive blade 4 (if “NO” in step S2), the connection position of the switch 53 is set to the position A, and the primary electrification bias voltage Vcg1 is applied, as the voltage applied to the blade, from the primary electrification bias power source 51 to the conductive blade 4 through the switch 53 (step S1). Therefore, the surface of the photoreceptor 2 is electrified to a negative potential, for example, −600 V, at the cleaning position P1. At this time, the primary electrification bias Vcg1 is not applied to the application brush roller 31 and only the process of applying the lubricant to the surface of the photoreceptor 2 is executed at the application position P0. In the first embodiment, the voltage Vcg1 applied to the blade is increased in steps from the start of printing using the image forming apparatus 1, in which a new conductive blade 4 is mounted, based on the accumulated printing number of sheets, that is, based on the number of durable sheets. The reason will be described in detail with reference to FIG. 4.

FIG. 4 is a diagram showing a relationship between the voltage applied to a blade and blade current in the apparatus of FIG. 1. As shown in the drawing, in the first embodiment, the primary electrification bias Vcg1 of DC −1.4 kV is applied to the new conductive blade 4 such that the surface of the photoreceptor 2 is electrified to a first potential (−600 V). As the printing number of sheets increases while constant voltage control in which the primary electrification bias Vcg1 (the voltage applied to the blade) is held at a predetermined value, it can be seen by an experiment that good image formation can be performed when the number of durable sheets is equal to or less than 2000, but blade current flowing between the conductive blade 4 and the photoreceptor 2 is remarkably reduced as denoted by a dashed dotted line of the drawing when the number of durable sheets exceeds 2000, non-uniformity of electrification occurs in the surface of the photoreceptor 2, and image quality deteriorates. That is, it can be seen that, in order to satisfactorily electrify the surface of the photoreceptor 2, the blade current needs to be held at a predetermined value Ith (for example, 25 μA) or more. In the first embodiment, in order to satisfactorily perform the primary electrification with respect to the surface of the photoreceptor 2 using the conductive blade 4, the primary electrification bias Vcg1 (the voltage applied to the blade) applied to the conductive blade 4 is increased in steps whenever the number of durable sheets becomes 1000, 2000, 3000 and 5000. Accordingly, the blade current flowing between the conductive blade 4 and the surface of the photoreceptor 2 is held at a predetermined value Ith or more such that the surface of the photoreceptor 2 is satisfactorily electrified. Therefore, the surface of the photoreceptor 2 can be uniformly and satisfactorily electrified over a long period of time. There is a limitation in the increase of the primary electrification bias Vcg1 (the voltage applied to the blade). In addition, the durability of the conductive blade 4 is prolonged, and thus it is difficult to maintain electrification uniformity.

In the first embodiment, the CPU 101 performs the determination (step S2) based on the number of durable sheets. In more detail, the CPU 101 counts the number of durable sheets, the counted value is stored in a memory (not shown), and a point in time when the number of durable sheets exceeds a predetermined value, for example, 10000, is determined a limit timing indicating that “the durability of the conductive blade 4 is prolonged and desired electrification uniformity cannot be obtained when the primary electrification is performed by the conductive blade 4”. The predetermined value may be determined based on an experiment or verification in advance and stored in the memory. The predetermined value may be changed by adding environmental conditions such as the temperature and humidity of the periphery of the image forming apparatus 1. Although the prolonged durability of the conductive blade 4 is determined by the number of durable sheets in the first embodiment, the prolonged durability of the conductive blade 4 may be determined based on other index values, for example, the total number of times of rotation of the photoreceptor 2 or the operation time of the image forming apparatus 1. A user may recognize the prolonged durability of the conductive blade 4 and input the prolonged durability through an external device such as an operation panel (not shown) of the image forming apparatus 1 or a computer connected to the image forming apparatus 1.

If the determination is “YES” in step S2, that is, if it is determined that the durability of the conductive blade 4 is prolonged and the primary electrification is not satisfactorily performed using the conductive blade 4, the CPU 101 switches the connection position of the switch 53 from the position A to the position B such that the primary electrification bias voltage Vcg1 is applied from the primary electrification bias power source 51 to the application brush roller 31 through the switch 53 (step S3). Accordingly, the surface of the photoreceptor 2 is electrified to a negative potential, for example, −600 V, at the application position P0.

As described above, according to the first embodiment, since the primary electrification bias Vcg1 is applied to at least one of the conductive blade 4 and the application brush roller 31 so as to perform the primary electrification process, the primary electrification process can be performed by a small number of parts. When the primary electrification of the surface of the photoreceptor 2 by the conductive blade 4 is continuously performed, electrification uniformity deteriorates due to the prolonged durability of the conductive blade 4, but the primary electrification using the conductive blade 4 is switched to the primary electrification using the application brush roller 31. Thus, electrification uniformity can be maintained over a long period of time.

Since the application of the bias to the conductive blade 4 is stopped by the switch and then the application of the bias to the conductive blade 4 is completely stopped, only the cleaning process using the conductive blade 4 is executed at the cleaning position P1. Accordingly, cleaning performance can be improved more than compared to when the primary electrification processes are simultaneously performed.

Since the primary electrification bias Vcg1 is applied to the application brush roller 31 in a state in which the number of durable sheets exceeds the predetermined value (in the first embodiment, 10000), the following effects can be obtained. That is, in the first embodiment, the lubricant is applied to the surface of the photoreceptor 2 so as to protect the surface of the photoreceptor 2 such that the abrasion is suppressed or a cleaning property of the residual toner after transfer is improved. Since the thickness of the lubricant bar 32 is decreased as the service of the apparatus is prolonged, the amount of lubricant scrapped off over time by the application brush roller 31 is decreased. In particular, in the scrapping using the brush, the surface of the lubricant bar 32 is not evenly shaved off, brush-mark-like irregularities are inevitably generated, and the amount of scraped lubricant is remarkably decreased. If the amount of scraped lubricant is decreased over time, it is difficult to maintain a stable amount of applied lubricant throughout the life span of the apparatus.

However, in the first embodiment, the primary electrification bias Vcg1 is applied to the application brush roller 31 so as to perform the primary electrification at the second half of the life span of the apparatus, in which the number of durable sheets exceeds the predetermined value. At this time, current flows between the brush hairs 31b of the application brush roller 31 and the photoreceptor 2. By this current, the temperature of the brush hairs 31b is increased and the lubricant of the surface of the lubricant bar 32 is softened by the increase of the temperature and the amount of lubricant scraped off by the brush hairs 31b is increased. As a result, it is possible to sufficiently apply the lubricant to the surface of the photoreceptor 2 even in the second half of the life span of the apparatus and to stabilize the amount of applied lubricant.

Although originally the positional relationship between the cleaning position P1 and the application position P0 is arbitrary, since the cleaning position P1 is located on the downstream side of the application position P0 in the rotation direction D2 in the first embodiment, the lubricant applied to the surface of the photoreceptor 2 by the lubricant applying unit 3 becomes uniform by using the conductive blade 4 such that the uniform lubricant film can be formed on the surface of the photoreceptor 2. Accordingly, it is possible to prevent the deterioration of the photoreceptor 2 by the lubricant and suppress the generation of a discharge product over the entire surface of the photoreceptor 2.

With respect to the electrification process of the surface of the photoreceptor 2, for example, a 1-step electrification process may be performed, for example, as in the apparatus described in JP-A-4-304476. However, in the first embodiment, since the 2-step electrification process is performed as described above, the following effects can be obtained.

In the 1-step electrification process is performed, for example, as described in JP-A-4-304476, a so-called overlapping bias in which DC and alternative current overlap with each other may be applied to the application brush roller 31 or the conductive blade 4. In this case, the polarity or the potential difference is significantly changed between the surface of the photoreceptor 2 and the application brush roller 31 or the conductive blade 4 and film scraping or the deterioration of the cleaning property may occur due to the deterioration of the photoreceptor 2 or non-uniformity of application or cleaning failure due to vibration may occur. In contrast, in the first embodiment, since a DC voltage (primary electrification bias Vcg1) having the same polarity of the regular electrification polarity of the toner is applied to the application brush roller 31 or the conductive blade 4 so as to perform the primary electrification of the surface of the photoreceptor 2, it is possible to suppress the deterioration of the photoreceptor 2, the cleaning failure and the non-uniformity of application and to satisfactorily perform the primary electrification process, the cleaning process and the application process.

In addition, a so-called no neutralization configuration is employed in which the primary electrification bias power source 51 controls the primary electrification bias Vcg1 of the DC voltage to be a constant voltage according to the operation command from the CPU 101 and thus a neutralization unit is not provided. That is, in the first embodiment, the application position P0 and the cleaning position P1 are reached in a state in which a surface region passing through the transfer position P5 out of the surface of the photoreceptor 2 is not neutralized. To this end, if the surface region is a non-exposure portion, since the light beam L is not irradiated, the surface potential of the surface region is the potential (that is, the second potential) adjusted by the previous secondary electrification process, the potential difference between the non-exposure portion and the application brush roller 31 or the conductive blade 4 is small and current flowing therebetween is small. Accordingly, it is possible to efficiently suppress the deterioration of the photoreceptor 2, the deterioration of the application brush roller 31 and the deterioration of the conductive blade 4, and to increase the life span of the apparatus. In particular, in the case of monochrome printing with a low average printing duty ratio, that is, a relatively wide non-exposure portion, the above effects are remarkable and effective. Accordingly, the invention is efficiently applied to a monochrome image forming apparatus for expertizely performing monochrome printing.

Since the primary electrification bias (the voltage applied to the blade) Vcg1 applied to the conductive blade 4 is increased in steps as the durability of the conductive blade 4 is prolonged, the blade current flowing between the conductive blade 4 and the surface of the photoreceptor 2 is always maintained at the predetermined value Ith or more such that the surface of the photoreceptor 2 can be satisfactorily electrified.

In the above embodiment, with respect to the primarily electrified surface of the photoreceptor 2, since the secondary electrification is performed by the so-called positive-polarity scorotron electrification device 5, the effect can be obtained in which there is hardly any discharge product or generation of ozone. In addition, the life span of the charge wire 5b can be increased. In addition, since it is impractical that there is completely no discharge product in the image forming apparatus 1 having the above configuration, an exhaust unit for releasing air from the periphery of the application position P0, the cleaning position P1 and the secondary electrification position P2 is preferably provided. In addition, it is preferable that an air current unit such as a fin for guiding air current is provided at the application position P0, the cleaning position P1 or the secondary electrification position P2 such that the efficiency of releasing the discharge product from the application position P0, the cleaning position P1 and the secondary electrification position P2 is improved.

In the above embodiment, since a so-called non-contact development method is employed to apply the toner from the development roller (toner carrier) 7a disposed to face the photoreceptor 2 in a non-contact manner to the surface of the photoreceptor 2 so as to develop the electrostatic latent image, the following effects can be obtained. That is, the external additive separated from the toner is one of factors which deteriorate the uniform electrification of the surface of the photoreceptor 2. Accordingly, when the separated external additive attached to the development roller 7a jumps from the development roller 7a and becomes attached to the photoreceptor 2, the surface of the photoreceptor 2 cannot be suitably electrified so as to cause defects in the image. In contrast, in the first embodiment, since the development roller 7a and the photoreceptor 2 are separated, it is difficult for the external additive separated from the toner and attached to the development roller 7a to jump to the photoreceptor 2 such that the occurrence of the above problems can be suppressed. In addition, in order to more efficiently suppress the jumping of the separated external additive from the development roller 7a, for example, the development roller 7a is preferably composed of a metallic development roller. If such a configuration is employed, the mirror image force of the external additive against the development roller 7a is increased and the separated external additive does not easily jump from the photoreceptor 2.

Although the primary electrification bias Vcg1 applied to the application brush roller 31 and the conductive blade 4 is controlled to be a constant voltage in the above embodiment, the current flowing between the application brush roller 31 or the conductive blade 4 and the photoreceptor 2 may be controlled to be a constant current. If constant current control is performed, a current flows between the non-exposure portion and the application brush roller 31 when the primary electrification process is performed at the application position P0 and a predetermined current flows between the non-exposure portion and the conductive blade 4 when the primary electrification process is performed at the cleaning position P1 such that the non-exposure portion is in an excessive electrification state. In order to prevent this problem, a neutralization unit is preferably provided between the transfer position P5 and the application position P0.

If the constant current control is performed as described above, the prolonged durability of the conductive blade 4 may be determined based on the primary electrification bias Vcg1 when the primary electrification process is performed at the cleaning position P1. That is, the primary electrification bias Vcg1 may be compared with a predetermined value instead of the number of durable sheets in step S2 and a point at which the primary electrification bias Vcg1 is applied may be switched from the conductive blade 4 to the application brush roller 31 based on the determination as to whether the primary electrification bias exceeds the predetermined value.

Although the surface of the photoreceptor 2 is electrified to the desired surface potential in the 2-step electrification method in the above embodiment, 1-step electrification may be performed, for example, by the electrification using the application brush roller 31 or the electrification using the conductive blade 4. That is, the overlapping voltage in which DC and AC overlap with each other is applied to the application brush roller 31 or the conductive blade 4 as the electrification bias and the electrification of the surface of the photoreceptor 2 may be completely performed simultaneously with the application process at the application position P0 or the cleaning process at the cleaning process P1. In this case, the electrification device 5 is unnecessary and the simplification and reduction in size of the apparatus can be achieved.

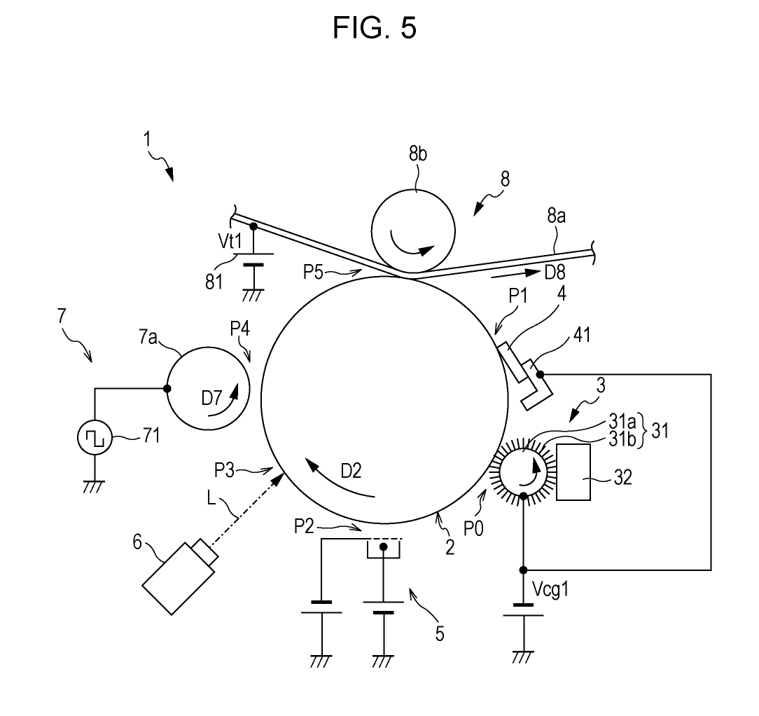

FIG. 5 is a diagram schematically showing the main configuration of an image forming apparatus according to a second embodiment of the invention. The second embodiment is different from the first embodiment in two points; the arrangement relationship between the lubricant applying unit 3 and the conductive blade 4, and the application of the primary electrification bias Vcg1; and is basically equal to the first embodiment in the other configuration. Accordingly, in the following description, the difference will be concentratively described.

In the second embodiment, as shown in FIG. 5, the conductive blade 4 and the lubricant applying unit 3 are provided from the upstream side to the downstream side of the rotation direction D2 of the photoreceptor 2 in this order. That is, the cleaning position P1 is located on the upstream side of the application position P0 in the rotation direction D2. In addition, the first electrification bias power source 51 is connected to the conductive blade 4 and the application brush roller 31, and the primary electrification bias Vcg1 is applied to the conductive blade 4 and the application brush roller 31 and is controlled to be a constant voltage similar to the first embodiment.

In the second embodiment having such a configuration, since the same DC voltage is applied to both the conductive blade 4 and the application brush roller 31, the primary electrification process can be executed with respect to the surface of the photoreceptor 2 at any one of the cleaning position P1 and the application position P0. In this embodiment, since the cleaning position P1 is located on the upstream side of the application position P0 as described above, the main part of the primary electrification process is performed at the cleaning position P1. That is, while the durability of the conductive blade 4 is not prolonged, the surface of the photoreceptor 2 is uniformly electrified by the conductive blade 4 at the cleaning position P1. To this end, the surface of the photoreceptor 2 is already electrified at the application downstream P0 located on the downstream side of the cleaning position P1 and the electrification process at the application position P0 is not performed or is performed as an auxiliary.

Meanwhile, if the durability of the conductive blade 4 is prolonged as the service of the apparatus is prolonged such that the electrification uniformity at the cleaning position P1 deteriorates, the electrification of a region, which is not sufficiently electrified, out of the surface of the photoreceptor 2 is performed using the application brush roller 31 at the application position P0, and then the electrification uniformity of the surface of the photoreceptor 2 is improved. In the second embodiment, as the durability of the conductive blade 4 is prolonged, the subject of the primary electrification process transitions from the conductive blade 4 to the application brush roller 31. Accordingly, as the service of the apparatus is prolonged, the durability of the conductive blade 4 is prolonged and thus the electrification uniformity by the conductive blade 4 deteriorates. However, since an electrification ratio by the application brush roller 31 is increased, electrification uniformity is ensured, and the electrification uniformity can be maintained over a long period of time. Even in the second embodiment, the same effects as the first embodiment can be obtained.

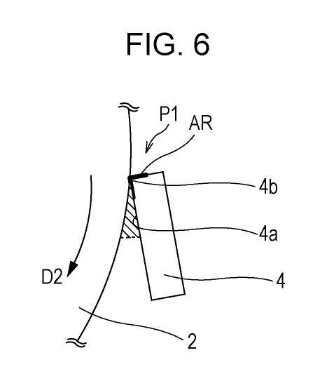

However, at the cleaning position P1, the conductive blade 4 is pressed against the surface of the photoreceptor 2 and the primary electrification bias Vcg1 is applied. Due to the influence of the load and the application of the bias, as shown in FIG. 6, the toner adheres to a ridge portion 4a, which is in contact with the surface of the photoreceptor 2, out of the front end of the conductive blade 4 and the adhesion of the toner is prompted by the influence of the lubricant. The adhesion portion AR is denoted by a thick line in the same drawing. If the adhesion portion AR remains, the primary electrification by the conductive blade 4 becomes unstable or the cleaning by the conductive blade 4 cannot be satisfactorily performed. Thus, defects in the image may occur.

In order to solve such problems, if the external additive having the polishing effect is contained in the toner used in the image forming apparatus 1, since the toner or the lubricant adhered to the ridge portion 4a of the conductive blade 4 is polished by the external additive, it is possible to suppress the growth of the adhesion portion AR with certainty. As a result, even when the image formation is continuously performed for a long period of time, it is possible to satisfactorily perform the primary electrification process and the cleaning process of the photoreceptor 2 by using the conductive blade 4. As the external additive having the polishing effect, for example, strontium titanate may be used.

In the image forming apparatus 1 which forms the image using the toner having the small particle diameter, some of the toner may pass through the conductive blade 4 so as to be attached to the blade surface 4b, the toner may be deposited on the blade surface 4b while the cleaning and the electrification are repeated by the conductive blade 4, the primary electrification at the cleaning position P1 may become unstable, and the electrification potential may be decreased. In order to solve such problems, an external additive having a leak function is preferably contained in the toner. That is, if the external additive (hereinafter, referred to as a “leak external additive”) having a leak function is contained in the toner attached to the conductive blade 4, even when the toner is attached to the conductive blade 4 due to the long-term use, electric charges are applied to the surface of the photoreceptor 2 through the leak external additive such that the surface of the photoreceptor 2 can be satisfactorily electrified. As a result, it is possible to satisfactorily form an image over a long period of time without generating electrification failure. When a leak external additive with a low separation rate is used, the separation of the leak external additive from the toner is suppressed and the above effect can be obtained with certainty. By setting the outer diameter of the leak external additive to be greater than that of an insulation external additive contained in the toner, it is possible to further stabilize primary electrification. As such a leak external additive, titania, semiconductor oxide (zinc oxide, tin oxide or the like), or inorganic particle, such as silica, obtained by applying a semi-conductive film such as ATO (obtained by doping antimony to tin oxide) or ITO (obtained by doping indium to tin oxide) to at least a portion of a surface may be used. In particular, among them, zinc oxide may be used as the leak external additive with the low separation rate.

The invention is not limited to the above-described embodiments and may be variously modified without departing from the scope of the invention. For example, although the positive-polarity scorotron electrification device 5 is used as the electrification device 5 for performing the secondary electrification, another electrification device such as a non-contact type roller electrification device or a contact type roller electrification device may be used. That is, electric charges having a polarity opposite to the regular electrification polarity are applied to the surface of the primarily electrified photoreceptor 2 so as to adjust the potential of the surface of the photoreceptor 2 to the second potential using the electrification device 5.

For example, the numerical values of the description of the above-described embodiments are only exemplary and the invention is not limited thereto. Although the negative electrification toner is used in the present embodiment, the invention is applicable to an image forming apparatus using positive electrification toner. In this case, the potential relationship between the units may be reversed.

Although the uniformly electrified surface of the photoreceptor 2 is exposed by the exposure unit 6 so as to form the electrostatic latent image in the image forming apparatuses of the above-described embodiments, a latent image forming unit for performing a function other than the exposure may be used if the electrostatic latent image can be formed on the surface of the electrified surface of the latent image carrier.

Although the number of development units 7 is not specifically described in the above-described embodiments, the invention is suitably applicable to a color image forming apparatus in which a plurality of development units is mounted in a rotatable rotary development unit, a so-called tandem type image forming apparatus in which a plurality of development units is arranged at the periphery of an intermediate transfer medium or a monochrome image forming apparatus in which only one development unit is included so as to form a monochrome image.

The entire disclosure of Japanese Patent Application No. 2009-077270, filed Mar. 26, 2009 is expressly incorporated by reference herein.

What is claimed is:

1. An image forming apparatus comprising:
a latent image carrier rotating in a predetermined rotation direction;
a lubricant applying unit configured to bring a conductive contact member into contact with a surface of the latent image carrier at a predetermined application position so as to apply a lubricant;
a development unit configured to attach toner to the surface of the latent image carrier, to which the lubricant is applied, at a development position located on a downstream side of the application position in the rotation direction so as to form a toner image; and
a conductive blade brought into contact with the surface of the latent image carrier at a cleaning position located on an upstream side of the development position in the rotation direction so as to remove the toner on the surface of the latent image carrier,
wherein a bias is applied to at least one of the conductive contact member and the conductive blade such that the surface of the latent image carrier is electrified, and
wherein, as the durability of the conductive blade is prolonged, a ratio of the electrification of the surface of the latent image carrier by the conductive blade and the electrification of the surface of the latent image carrier by the conductive contact member is changed.

2. The image forming apparatus according to claim 1, further comprising a switching unit configured to changing the ratio by switching a point at which the bias is applied.

3. The image forming apparatus according to claim 2, wherein the switching unit switches the point at which the bias is applied from the conductive blade to the conductive contact member.

4. The image forming apparatus according to claim 2, wherein the cleaning position is located on a downstream side of the application position in the rotation direction.

5. The image forming apparatus according to claim 1, wherein:
the cleaning position is located on an upstream side of the application position in the rotation direction, and
the same direct current voltage is applied as the bias to both the conductive contact member and the conductive blade.

6. The image forming apparatus according to claim 1, further comprising an electrification device configured to electrify the surface of the latent image carrier on a downstream side of the cleaning position and the application position and at a secondary electrification position located on an upstream side of the development position in the rotation direction,
wherein the bias is applied such that the surface of the latent image carrier is electrified to a first potential at an upstream side of the secondary electrification position, and
wherein the surface of the latent image carrier electrified to the first potential is electrified to a second potential by the electrification device at the secondary electrification position.

7. The image forming apparatus according to claim 6, wherein:
the direct current voltage having the same polarity as a regular electrification polarity of the toner is applied as the bias such that the surface of the latent image carrier is electrified to the first potential having the same polarity as the regular electrification polarity on the upstream side of the secondary electrification position, and
electric charges having a polarity opposite to the regular electrification polarity are applied by the electrification device such that the potential of the surface of the latent image carrier is adjusted to the second potential.

8. The image forming apparatus according to claim 1, wherein an overlapping voltage in which an alternating current voltage overlaps with a direct current voltage having the same polarity as a regular electrification polarity of the toner is applied as the bias such that the surface of the latent image carrier is electrified.

9. The image forming apparatus according to claim 1, wherein:
the conductive contact member is an application brush roller, and
in the application brush roller, a movement direction of a front end of the brush of the application brush roller is the same as a movement direction of the surface of the latent image carrier at the application position, and the front end of the brush is rotated while being brought into contact with the surface of the latent image carrier.

10. The image forming apparatus according to claim 9, wherein a movement velocity of the front end of the brush at the application position is faster than a movement velocity of the surface of the latent image carrier at the application position.

11. The image forming apparatus according to claim 1, wherein the development unit has a toner carrier disposed to face the latent image carrier in a non-contact manner at the development position, and the toner is applied from the toner carrier to the surface of the latent image carrier so as to form the toner image.

12. The image forming apparatus according to claim 1, wherein the toner contains an external additive having polishing effect.

13. The image forming apparatus according to claim 12, wherein the external additive having the polishing effect is strontium titanate.

14. The image forming apparatus according to claim 1, wherein the toner contains an external additive having a leak function.

15. The image forming apparatus according to claim 14, wherein the external additive having the leak function is titania, semiconductor oxide, or inorganic particles obtained by applying a semi-conductive film to at least a portion of a surface.

16. The image forming apparatus according to claim 1, wherein a volume average particle diameter of the toner is 5 μm or less and circularity of the toner is 0.95 or more.

17. An image forming method comprising:
bringing a conductive contact member to a surface of a latent image carrier rotating in a predetermined rotation direction so as to apply a lubricant;
attaching toner to the surface of the latent image carrier, to which the lubricant is applied, to form a toner image;
transferring the toner image onto a transfer medium;
bringing a conductive blade into contact with the surface of the latent image carrier so as to clean and remove the toner remaining on the surface of the latent image carrier after transfer; and
applying a bias to at least one of the conductive contact member and the conductive blade so as to electrify the surface of the latent image carrier,
wherein, in the electrifying, as the durability of the conductive blade is prolonged, a ratio of the electrification of the surface of the latent image carrier by the conductive blade and the electrification of the surface of the latent image carrier by the conductive contact member is changed.
